(19) United States
(12) Patent Application Publication
(10) Pub. No.: US 2020/0265843 A1
(43) Pub. Date: Aug. 20, 2020

(54) SPEECH BROADCAST METHOD, DEVICE AND TERMINAL

(71) Applicant: Baidu Online Network Technology (Beijing) Co., Ltd, Beijing (CN)

(72) Inventor: Taotao Zhao, Beijing (CN)

(73) Assignee: Baidu Online Network Technology (Beijing) Co., Ltd., Beijing (CN)

(21) Appl. No.: 16/601,629

(22) Filed: Oct. 15, 2019

(30) Foreign Application Priority Data
Feb. 20, 2019 (CN) 201910127222.2

(51) Int. Cl. G10L 17/04; G10L 25/63; G10L 17/00; G10L 25/90

(52) U.S. Cl. CPC G10L 17/04; G10L 25/90; G10L 17/005; G10L 25/63

(57) ABSTRACT

A speech broadcast method, device and terminal are provided. The method includes: obtaining a current conversation speech from a user; identifying a tone type of the current conversation speech with a tone identification model; selecting a broadcast tone according to the identified tone type; and generating a broadcast speech according to the selected broadcast tone. A tone type of a current conversation speech is identified with a tone identification model, and a broadcast tone for broadcasting is selected, so that the broadcast speech generated by using the broadcast tone suitable to a user mood, improving cordial feeling during the interaction, and providing a more user-friendly interactive experience.

### CROSS-REFERENCE TO RELATED APPLICATION

This application claims priority to Chinese Patent Application No. 201910127222.2, filed on Feb. 20, 2019 and entitled “Speech Broadcast Method, Device and Terminal”, which is hereby incorporated by reference in its entirety.

### TECHNICAL FIELD

The present application relates to the field of intelligent broadcast technology, and in particular, to a speech broadcast method, device and terminal.

### BACKGROUND

In daily life, when people are talking with a second person, he/she will determine a mood of the second person according to an expression, a tone and movement of the second person, and will make a response according to the mood of the second person. For example, if the second person is happy, it is better to make a response in a lively tone. If the second person is sad and in a low mood, it is better to comfort the second person and make a response in a slow and gentle tone. Nowadays, smart speakers can make a conversation with a user and respond to the user with a unified speech broadcast manner. However, it cannot respond to the user with respective tones according to respective moods of the user. Broadcasting with the unified speech broadcast manner may be dull, and is less cordial during interaction with people.

### SUMMARY

A speech broadcast method, device and storage terminal are provided according to embodiments of the present application, so as to at least solve the above technical problems in the existing technology.

In a first aspect, a speech broadcast method is provided according to embodiments of the present application, the method including:

obtaining a current conversation speech from a user;

identifying a tone type of the current conversation speech with a tone identification model;

selecting a broadcast tone according to the identified tone type; and

generating a broadcast speech according to the selected broadcast tone.

In one implementation, before identifying a tone type of the current conversation speech with a tone identification model, the method further includes:

extracting a conversation speech feature from sample conversation speeches, wherein the conversation speech feature includes at least one of a speech rate, a speech tone and a speech volume; and

training the tone identification model according to the conversation speech feature.

In one implementation, before identifying a tone type of the current conversation speech with a tone identification model, the method includes:

extracting a wake-up speech feature from sample wake-up speeches, wherein the wake-up speech feature includes at least one of a speech rate, a speech tone and a speech volume; and

training the tone identification model according to the wake-up speech feature.

In one implementation, selecting a broadcast tone according to the tone type of the current conversation speech, includes:

in a case that the identified tone type is a gentle tone, selecting the gentle tone as the broadcast tone;

in a case that the identified tone type is a lively tone, selecting the lively tone as the broadcast tone; or

in a case that the identified tone type is a low tone, selecting the low tone as the broadcast tone.

A speech broadcast device is provided according to embodiments of the present application, the device including:
a speech acquiring module configured to obtain a current conversation speech from a user;
a type identifying module configured to identify a tone type of the current conversation speech with a tone identification model;
a tone selecting module configured to select a broadcast tone according to the identified tone type; and
a speech generating module configured to generate a broadcast speech according to the selected broadcast tone.

In one implementation, the speech broadcast device further includes:
a first extracting module configured to extract a conversation speech feature from sample conversation speeches, wherein the conversation speech feature includes at least one of a speech rate, a speech tone and a speech volume; and
a first training module configured to train the tone identification model according to the conversation speech feature.

In one implementation, the speech broadcast device further includes:
a second extracting module configured to extract a wake-up speech feature from sample wake-up speeches, wherein the wake-up speech feature includes at least one of a speech rate, a speech tone and a speech volume; and
a second training module configured to train the tone identification model according to the wake-up speech feature.

In one implementation, wherein tone selecting module includes
a first selecting unit configured to, in a case that the identified tone type is a gentle tone, select the gentle tone as the broadcast tone;
a second selecting unit configured to, in a case that the identified tone type is a lively tone, select the lively tone as the broadcast tone; or
a third selecting unit configured to, in a case that the identified tone type is a low tone, select the low tone as the broadcast tone.

In a third aspect, a speech broadcast terminal is provided according to embodiments of the present application. The functions of the terminal may be implemented by hardware or by executing corresponding software with hardware. The hardware or software includes one or more modules corresponding to the functions described above.

In a possible embodiment, the terminal structurally includes a processor and a memory, wherein the memory is configured to store programs which support the device to execute the above speech broadcast method, and the processor is configured to execute the programs stored in the memory. The device may further include a communication interface through which the device communicates with other devices or communication networks.

In a fourth aspect, a computer-readable storage medium is provided for storing computer software instructions used by the speech broadcast device, wherein the computer software instructions include programs involved in execution of the above speech broadcast terminal.

One of the above technical solutions has the following advantages or beneficial effects. In the speech broadcast method provided by the present technical solution, a tone type of a current conversation speech is identified with a tone identification model, and a broadcast tone for broadcasting is selected, so that the broadcast speech generated by using the broadcast tone suitable to a user mood, improving cordial feeling during the interaction, and providing a more user-friendly interactive experience.

The above summary is for the purpose of the specification only and is not intended to be limiting in any way. In addition to the illustrative aspects, embodiments, and features described above, further aspects, embodiments, and features of the present application will be readily understood by reference to the drawings and the following detailed description.

### BRIEF DESCRIPTION OF THE DRAWINGS

In the drawings, unless otherwise specified, identical reference numerals will be used throughout the drawings to refer to identical or similar parts or elements. The drawings are not necessarily drawn to scale. It should be understood that these drawings depict only some embodiments disclosed in accordance with the present application and are not to be considered as limiting the scope of the present application.

FIG. 1 shows a flow chart of a speech broadcast method according to an embodiment of the present application.

FIG. 2 shows a schematic diagram of another speech broadcast method according to an embodiment of the present application.

FIG. 3 shows a flow chart of another speech broadcast method according to an embodiment of the present application.

FIG. 4 shows a structural block diagram of a speech broadcast device according to an embodiment of the present application.

FIG. 5 shows a flow chart of another speech broadcast method according to an embodiment of the present application.

FIG. 6 shows a flow chart of another speech broadcast method according to an embodiment of the present application.

FIG. 7 shows a flow chart of another speech broadcast method according to an embodiment of the present application.

FIG. 8 shows a schematic diagram of a speech broadcast terminal according to an embodiment of the present application.

### DETAILED DESCRIPTION OF THE EMBODIMENTS

In the following, only certain exemplary embodiments are briefly described. As those skilled in the art would realize, the described embodiments may be modified in various different ways, all without departing from the spirit or scope of the present application. Accordingly, the drawings and description are to be regarded as illustrative in nature and not restrictive.

### Embodiment 1

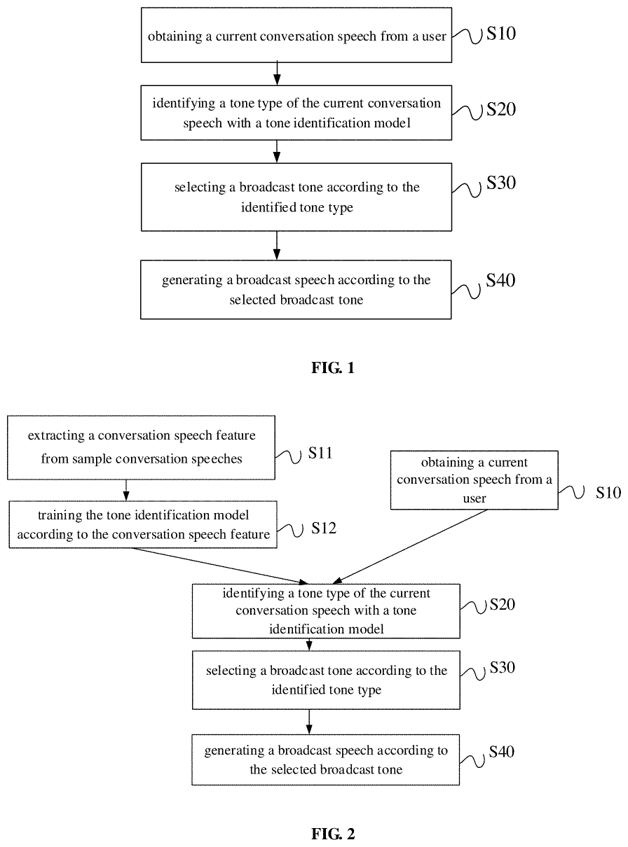

In a specific embodiment, as shown in FIG. 1, a flow chart of a speech broadcast method is provided, the method including Step S10 to Step S40.

Step S10: obtaining a current conversation speech from a user;

Step S20: identifying a tone type of the current conversation speech with a tone identification model;

Step S30: selecting a broadcast tone according to the identified tone type; and

Step S40: generating a broadcast speech according to the selected broadcast tone.

In one example, the method can be applied to an interactive device such as a smart speaker. The tone identification model is trained in advance through conversation speeches between the user and the smart speaker during an interaction process, and then each time the smart speaker receives a current conversation speech, the tone identification model can be used to identify the tone type of the current conversation speech. Generally, the identified tone type of the current conversation speech can reflect the mood of the user when waking up the smart speaker or when making a request to the smart speaker. Based on the identified tone type of the current conversation speech, a broadcast tone is retrieved in the database. Then, the broadcast speech is generated with the retrieved tone. In this way, the broadcast speech of the smart speaker is more suitable to the user mood. For example, if the tone of the user is of a low tone type, the interactive device such as a smart speaker can make a response to the user with a low broadcast tone. If the tone of the user is of a lively tone type, the interactive device such as a smart speaker can make a response to the user with a lively broadcast tone. If the tone of the user is of a gentle tone type, the interactive device such as a smart speaker can make a response to the user with a gentle broadcast tone.

In the speech broadcast method of the embodiment, operations of the interactive device such as the smart speaker can be more humanized, and it is possible to make a response to the user with respective broadcast tone according to respective tone types of the user, so that the interaction between the user and the smart speaker could be smoother. Meanwhile, since the response of the smart speaker can be made according to the user mood, the interest of the user to interact with the smart speaker could be improved.

In an embodiment, as shown in FIG. 2, before step S20, the method further includes:

Step S11: extracting a conversation speech feature from sample conversation speeches, wherein the conversation speech feature includes at least one of a speech rate, a speech tone and a speech volume; and

Step S12: training the tone identification model according to the conversation speech feature.

In one example, the sample conversation speech could include a speech for requesting the smart speaker to automatically perform some functions after the smart speaker is waken up, for example, “I want to listen to the song”, “I have to travel, and I want to know the weather in Shanghai for the next three days”, “I want to cook, and please provide recipes and cooking steps”, etc. . . . A conversational speech feature is extracted from sample conversation speech. For example, if the sample conversation speech is “I want to listen to the song”, the sample conversation speeches can be constructed by speeches from a large number of users when outputting “I want to listen to songs” with the tone types such as low tone, pleasant tone, and gentle tone. The conversation speech feature extracted from the sample conversation speeches include a numerical range for a slow speech rate, a numerical range for a low speech tone, a numerical range for a smaller volume, a numerical range for a faster speech rate, a numerical range for a rising tone, a numerical range for a larger volume, a numerical range for a moderate speech rate, a numerical range for a gentle tone, a numerical range of a medium volume. With the speech feature above to train the tone identification model, the trained tone identification model can be used for identifying a depressed mood of the user by identifying the low tone of the user, identifying a happy mood of the user by identifying the pleasant tone of the user, and identifying a gentle mood by identifying the gentle tone of the user.

It should be noted that the trained tone identification model includes, but is not limited to, the above three tone types, and the tone identification model trained according to actual requirements can be used to identify more specific tone types, which are all within the protection scope of the present embodiment.

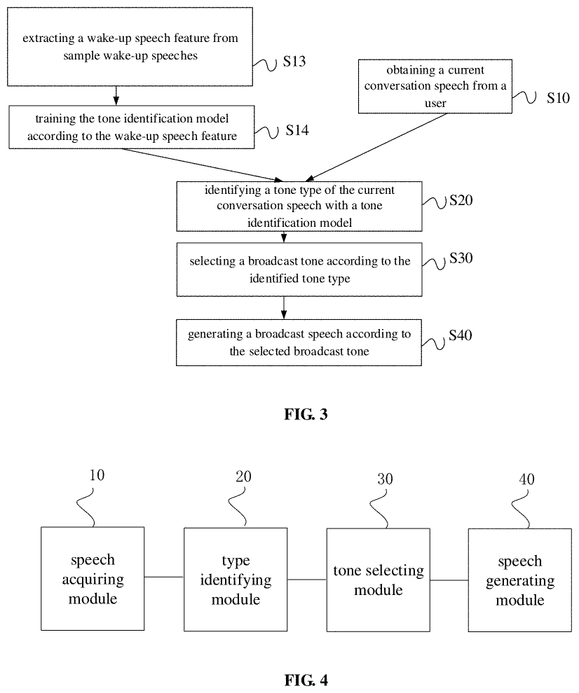

In an embodiment, as shown in FIG. 3, before step S20, the method further includes Step S13 and Step S14.

Step S13: extracting a wake-up speech feature from sample wake-up speeches, wherein the wake-up speech feature includes at least one of a speech rate, a speech tone and a speech volume;

Step S14: training the tone identification model according to the wake-up speech feature.

In one example, a sample wake-up speech may be a speech for waking up a smart device such as a smart speaker. The sample wake-up speech may include a preset wake-up word, and the smart speaker may be waked up by identifying the wake-up word. For example, the wake-up word in a sample wake-up speech may be “Xiao Du, Xiao Du”, and the like. Generally, other wake-up words may also be set according to user requirements. For example, the sample wake-up speech may also be “hello”, “open smart speaker”, etc., which are all within the protection scope of this embodiment. In the extracting the speech feature from sample wake-up speeches, for example, if the wake-up word in sample wake-up speech is “Xiao Du, Xiao Du”, the sample wake-up speeches may be formed by speeches output by a large number of users with a tone type such as a low tone, a pleasant tone and a gentle tone in speaking “Xiao Du, Xiao Du”. The conversation speech features extracted from the sample conversation speech include a numerical range for a slow speech rate, a numerical range for a low speech tone, a numerical range for a smaller volume, a numerical range for a faster speech rate, a numerical range for a rising tone, a numerical range for a larger volume, a numerical range for a moderate speech rate, a numerical range for a gentle tone, a numerical range of a medium volume. With the speech feature above to train the tone identification model, the trained tone identification model can be used for identifying a depressed mood of the user by identifying the low tone of the user, identifying a happy mood of the user by identifying the pleasant tone of the user, and identifying a gentle mood by identifying the gentle tone of the user.

It should be noted that a sample used to train the tone identification model can be either a sample conversation speech or a sample wake-up speech. Generally, it can also be a combination of sample conversation speech and sample wake-up speech, which can be used to train the tone identification model. The trained models are all within the protection scope of the present application.

In an embodiment, selecting a broadcast tone according to the tone type of the current conversation speech, includes:

in a case that the identified tone type is a gentle tone, selecting the gentle tone as the broadcast tone;

in a case that the identified tone type is a lively tone, selecting the lively tone as the broadcast tone; or

in a case that the identified tone type is a low tone, selecting the low tone as the broadcast tone.

In an example, when a device such as a smart speaker responds to a user request, in order to make it more suitable to the user mood, thereby improving the communication interest of the user, etc., the device such as a smart speaker identifies the tone type of the current conversation speech and select a broadcast tone in database according to the identified tone type, wherein, the correspondence between the tone type of the current conversation speech and the broadcast tone can be stored in the database, so as to improve a search efficiency. It should be noted that, including but not limited to the above three types of moods, more detailed division of the tone types could be made according to requirements, and they are all in the protection scope of the present embodiment.

### Embodiment 2

In a specific implementation, as shown in FIG. 4, a speech broadcast device is provided, including:

a speech acquiring module 10 configured to obtain a current conversation speech from a user;

a type identifying module 20 configured to identify a tone type of the current conversation speech with a tone identification model;

a tone selecting module 30 configured to select a broadcast tone according to the identified tone type; and

a speech generating module 40 configured to generate a broadcast speech according to the selected broadcast tone.

In an embodiment, as shown in FIG. 5, the device further includes:

a first extracting module 11 configured to extract a conversation speech feature from sample conversation speeches, wherein the conversation speech feature includes at least one of a speech rate, a speech tone and a speech volume; and

a first training module 12 configured to train the tone identification model according to the conversation speech feature.

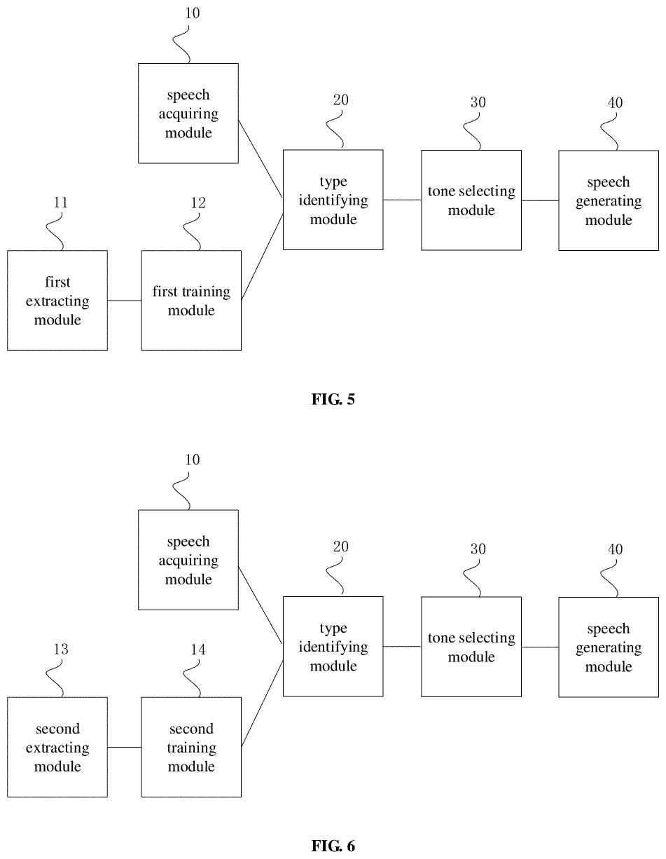

In an embodiment, as shown in FIG. 6, the device further includes:

a second extracting module 13 configured to extract a wake-up speech feature from sample wake-up speeches, wherein the wake-up speech feature includes at least one of a speech rate, a speech tone and a speech volume;

a second training module 14 configured to train the tone identification model according to the wake-up speech feature.

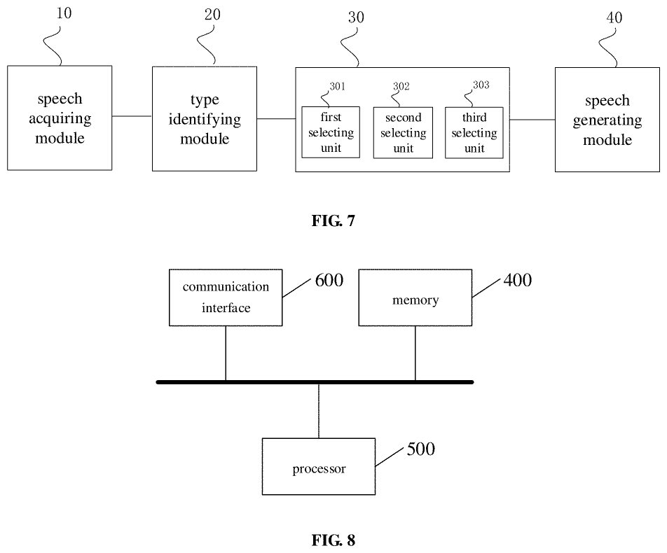

In an embodiment, as shown in FIG. 7, the tone selecting module 30 includes:

a first selecting unit 301 configured to, in a case that the identified tone type is a gentle tone, select the gentle tone as the broadcast tone;

a second selecting unit 302 configured to, in a case that the identified tone type is a lively tone, select the lively tone as the broadcast tone; or

a third selecting unit 303 configured to, in a case that the identified tone type is a low tone, select the low tone as the broadcast tone.

### Embodiment 3

The embodiment of the present application provides a speech broadcast terminal, as shown in FIG. 8, including:

a memory 400 and a processor 500. The memory 400 stores a computer program executable on the processor 500. When the processor 500 executes the computer program, a speech signal recognition method in the foregoing embodiment is implemented. The number of the memory 400 and the processor 500 may be one or more.

The device further includes a communication interface 600 configured to communicate with external devices and exchange data.

The memory 400 may include a high-speed RAM memory and may also include a non-volatile memory, such as at least one magnetic disk memory.

If the memory 400, the processor 500, and the communication interface 600 are implemented independently, the memory 400, the processor 500, and the communication interface 600 may be connected to each other through a bus and communicate with one another. The bus may be an Industry Standard Architecture (ISA) bus, a Peripheral Component (PCI) bus, an Extended Industry Standard Component (EISA) bus, or the like. The bus may be divided into an address bus, a data bus, a control bus, and the like. For ease of illustration, only one bold line is shown in FIG. 8, but it does not mean that there is only one bus or one type of bus.

Optionally, in a specific implementation, if the memory 400, the processor 500, and the communication interface 600 are integrated on one chip, the memory 400, the processor 500, and the communication interface 600 may implement mutual communication through an internal interface.

### Embodiment 4

According to an embodiment of the present application, a computer-readable storage medium is provided for storing computer programs. When executed by the processor, the programs implement any of the methods according to above embodiments.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or device (such as a computer-based system, a processor-included system, or other system that fetch instructions from an instruction execution system, device, or device and execute the instructions). For the purposes of this specification, a “computer-readable medium” may be any device that may contain, store, communicate, propagate, or transport the program for use by or in connection with the instruction execution system, device, or device. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A speech broadcast method, comprising:
obtaining a current conversation speech from a user;
identifying a tone type of the current conversation speech with a tone identification model;
selecting a broadcast tone according to the identified tone type; and
generating a broadcast speech according to the selected broadcast tone.

2. The speech broadcast method according to claim 1, wherein before identifying a tone type of the current conversation speech with a tone identification model, the method further comprises:
extracting a conversation speech feature from sample conversation speeches, wherein the conversation speech feature comprises at least one of a speech rate, a speech tone and a speech volume; and
training the tone identification model according to the conversation speech feature.

3. The speech broadcast method according to claim 1, wherein before identifying a tone type of the current conversation speech with a tone identification model, the method comprises:
extracting a wake-up speech feature from sample wake-up speeches, wherein the wake-up speech feature comprises at least one of a speech rate, a speech tone and a speech volume; and
training the tone identification model according to the wake-up speech feature.

4. The speech broadcast method according to claim 1, wherein selecting a broadcast tone according to the tone type of the current conversation speech, comprises:
in a case that the identified tone type is a gentle tone, selecting the gentle tone as the broadcast tone;
in a case that the identified tone type is a lively tone, selecting the lively tone as the broadcast tone; or
in a case that the identified tone type is a low tone, selecting the low tone as the broadcast tone.

5. A speech broadcast device, comprising:
one or more processors; and
a storage device configured for storing one or more programs, wherein
the one or more programs are executed by the one or more processors to enable the one or more processors to:
obtain a current conversation speech from a user;
identify a tone type of the current conversation speech with a tone identification model;
select a broadcast tone according to the identified tone type; and
generate a broadcast speech according to the selected broadcast tone.

6. The device according to claim 5, wherein the one or more programs are executed by the one or more processors to enable the one or more processors to:
extract a conversation speech feature from sample conversation speeches, wherein the conversation speech feature comprises at least one of a speech rate, a speech tone and a speech volume; and
train the tone identification model according to the conversation speech feature.

7. The device according to claim 5, wherein the one or more programs are executed by the one or more processors to enable the one or more processors to:
extract a wake-up speech feature from sample wake-up speeches, wherein the wake-up speech feature comprises at least one of a speech rate, a speech tone and a speech volume; and
train the tone identification model according to the wake-up speech feature.

8. The device according to claim 5, wherein the one or more programs are executed by the one or more processors to enable the one or more processors to:
in a case that the identified tone type is a gentle tone, select the gentle tone as the broadcast tone;
in a case that the identified tone type is a lively tone, select the lively tone as the broadcast tone; or
in a case that the identified tone type is a low tone, select the low tone as the broadcast tone.

9. A non-volatile computer readable storage medium in which a computer program is stored, wherein the computer program, when executed by a processor, implements the method of claim 1.
